(19) United States
(12) Patent Application Publication
(10) Pub. No.: US 2018/0356546 A1
(43) Pub. Date: Dec. 13, 2018

(54) METHOD OF MEASUREMENT AND APPARATUS FOR MEASUREMENT OF AMPLITUDE RATIO OF TWO FIRST HARMONICS OF THE SIGNAL OBTAINED FROM SAGNAC SYSTEM

(71) Applicants: WOJSKOWA AKADEMIA TECHNICZNA IM. JAROSLAWA DABROWSKIEGO, Warszawa (PL); M-SOFT SP. Z O. O., Warszawa (PL)

(72) Inventors: Jerzy K. Kowalski, Warszawa (PL); Leszek R. Jaroszewicz, Warszawa (PL); Zbigniew Krajewski, Warszawa (PL); Anna Kurzych, Piekoszów (PL); Pawel Marc, Legionowo (PL)

(73) Assignees: WOJSKOWA AKADEMIA TECHNICZNA IM. JAROSLAWA DABROWSKIEGO, Warszawa (PL); M-SOFT SP. Z O. O., Warszawa (PL)

(21) Appl. No.: 16/060,903

(22) PCT Filed: Dec. 10, 2015
(86) PCT No.: PCT/IB2015/059521

§ 371 Date: Jun. 8, 2018

(51) Int. Cl. G01V 1/22; G01C 19/72; G02B 6/10; G01B 9/02

(52) U.S. Cl. CPC G01V 1/226; G01B 9/02015; G02B 6/105; G01C 19/721

(57) ABSTRACT

The object of the present invention is a measurement method and a system for measurement of an amplitudes ratio of two first harmonics of a signal obtained from the Sagnac fibre-optic inter-ferometer system as well as the Sagnac fibre-optic system, and an application of the said system to measure the amplitude ratio of two first harmonics obtained from the Sagnac fibre-optic system and the Sagnac fibre-optic interferometer system for detection of rotational movements, in particular seismic rotational movements and rotational movements of structures.

The object of the present invention is the method of measurement and the apparatus for measurement of amplitude ratio of two first harmonics of the signal obtained from Sagnac system.

The application of the Sagnac effect for construction of a fibre-optic rotation sensor was proposed in mid 70s of the previous century. In mid eighties, the system assumed the form of a commercial apparatus called fibre-optic gyroscope, used for navigation of aircraft and vehicles, guiding missiles, and for inertial navigation of spacecraft. During the research carried out by many research grups, a few different configurations of the fibre-optic gyroscope were developed.

The basic configuration of the interferometric fibre-optic gyroscope, as illustrated in FIG. 1, consists of a broadband light source, like a superluminescent diode 1 whose light is split into two identical waves by the fibre-optic coupler 2 of 2×2 type. After passing through the couple, the two light beams travel uniformly in opposite directions in the fibre-optic loop 3. Next, having passed through the loop, the returning waves interfere with each other in the coupler, and the interference signal is processed by the photo-detector 4. The basic system is not a reversible system in case of lack of rotation. It means that both light waves do not cover the same optical distance. The light wave propagating clockwise (CW) is reflected twice by means of the fibre-optic coupler, while the light wave propagating counter-clockwise (CCW) is transmitted twice, which introduces a specific value of irreversibility.

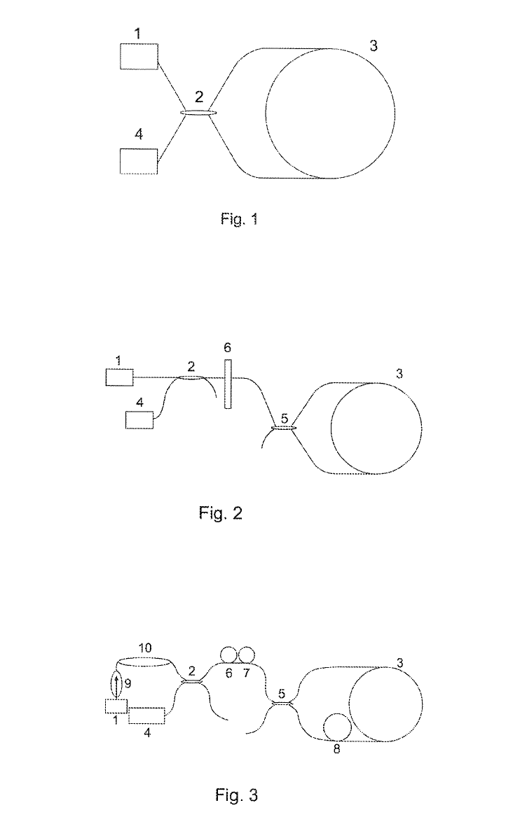

The reversibility is provided by a system using the so-called minimum configuration, illustrated in FIG. 2 where another coupler 2 has been added apart from the superluminescent diode 1, fibre-optic loop 3, photo-detector 4, coupler 2 of 2×2 type, in order to provide the identical optical path for the waves propagating both clockwise and counter-clockwise. Furthermore, polariser 6, having the function of a single-mode filter, was used between couplers 2 and 5, resulting in that the two light waves return to the coupler with the same polarisation, thus creating the intereference image on the photo-detector.

One of the fundamental questions contemplated on construction of measurement systems based on Sagnac fibre-optic interferometer wast the modulation and detection system. In case of detection of small phase differences caused by the rotation, the detected signal practically does not change, which results from slow changes in cosine function values around zero. In order to move the interferometer operation point into the maximum sensitivity area where the interferometer response is the highest for small changes of excitation, a fibre-optic phase modulator is used, situated at the end of the loop and powered with voltage of ω pulsation. It causes the beams propagating in the opposite directions to undergo the same modulation, but in a certain interval. If the sensor loop does not rotate, then the output signal contains only even harmonics of the modulated phase.

While in the presence of rotation, odd harmonics occur in the output signal, with the amplitude depending on the angular velocity and the phase depending on the rotation direction. Therefore, measurement and processing of one of the odd harmonics in the output signal enables determination of the angular velocity and its direction. Such configuration is represented by a fibre-optic gyroscope with the open feedback loop. Its drawback is the dependence of calibration upon the light source intensity. This method is used in measurements where moderate ranges of dynamics and drift, and high level of accuracy are required.

Gyroscopes with a closed fibre-optic loop are additionally equipped with feedback input into the element changing the phase. In such configuration, digital frequency shift of beams running opposite to each other is used. The solution enables reaching high dynamics range, high accuracy and minimum drift.

There are many works in the art, presenting fibre-optic gyroscopes. And so, in a review work titled “Fiber optic sensors”, S. Yin, P. B. Ruffin and F. T. S. Yu (eds.) published in 2008 by CRC Press, the most often used configurations of Sagnac fibre-optic interferometer are presented. The general principle of operation of that system as well as sources of parasitic effects and the ways of their removal. The collective work titled “Optical Gyros and their Application”, published as RTO AG-339 NATO report of May 1999 should be viewed in the same manner.

In chapter 16 titled “Fiber Gyroscope Principles” by Sabina Merlo, Michele Norgiai and Silvano Donati, in the book “Handbook of Fibre Optic Sensing Technology,” Jose Miguel López-Higuera (ed.), the description of the basic principles concerning fibre optic gyroscopes can be found. In the chapter referred to above, we can find the descriptions of individual configurations, the apparatus efficiency limits, and detection systems.

In the work titled “Application of the Sagnac Effect in the Interferometric Fiber-Optic Gyroscope” by Herve C. Lefevre, EuroFOG—PHOTONETICS, the basic principles ruling Sagnac interferometer and a fibre-optic gyroscope configuration providing reversibility were presented. The coherence and polarisation of light in the described systems were pointed out, and the techniques of signal processing were presented. Article titled “Low Drift and High Sensitivity Fiber Optic Gyroscope Using Tunable VCSEL as Optical Source” by Carlos F. R. Mateus, Camila D. Sardeto and Carmen L. Barbosa (2009) proposes the application of swept source of VCSEL (Vertical Cavity Surface Emitting Laser) type for construction of a fibre-optic gyroscope, which shall result in low drift and noise levels. The data presented in the article state that such approach can facilitate the control and stabilization of the light source.

Also, many solutions concerning the Sagnac interferometer system have been proposed. For example, the American Patent Application No. US005214488A discloses a schematic of digital phase modulation in the Sagnac interferometer system with the open feedback loop, aimed at the elimination of unfavourable phenomenon connected with accidental signal modulation.

American Patent document No. U.S. Pat. No. 5,137,359 presents a fibre-optic Sagnac interferometer that uses configurations with an open fibre-optic loop and a digital phase modulator. On application of the described invention, costly analog-digital converters and analog modules can be eliminated. When the presented phase modulator is used, the applied voltage on the mudulator is much less coherent with the signal phase shift in the pre-amplifier and photo-detector. The electrodes of the digital modulator in the said patent comprise a ssegmented matrix of elements.

On the other hand, American Patent document No. U.S. Pat. No. 5,268,740 discloses a modulation solution for fibre-optic rotation sensors based on the Sagnac interferometer with a short fibre-optic loop. The system in the said patent comprises a signal modulation generator that uses a control device placed to receive the readout of the modulated signals and interact with the control device output signal. The controller settings ara such that the amplitude of the control variables for the generator signal is the direct measurement of the angular velocity.

In the present invention, the minimal configuration of the Sagnac fibre-optic interferometer was used, described in the work by R. Ulrich, “Fibre-Optic Rotation Sensing with Low Drift,” Optics Letters, vol. 5, 1980, pp. 173-175, illustrated in FIG. 3, using a broadband light beam source 1 equipped additionally with an isolator 9 and a fibre-optic depolariser 10 in order to reduce the reverse signal and polarisation noise. Apart from these elements, the system comprises: a pari of fibre-optic couplers 2 and 5 of 2×2 type, a pair of polarisers 6 and 7, a fibre-optic phase modulator 8, and a fibre-optic loop 3. In this system configuration, the methods to measure rotational speed used so far were realised be means of an analog-digital converter of very high dynamics. The output signal was sampled, and in order to separate individual harmonic amplitudes of the signal, Fourier transform was used. Due to the fact that the usable information on the rotational speed is included in the ratio of the first and second harmonic amplitude of the signal and the levels of those signals differ by million times, the electronic system required for the measurement had to be very accurate and thus expensive. At the same time, it was difficult to obtain high accuracy of the measurement system outside laboratory conditions.

Therefore, the purpose of the present invention is the development of the measurement method and a system to measure the ratio of amplitudes of the first two harmonics of the signal obtained from a Sagnac system, providing very accurate rotational speed measurement results.

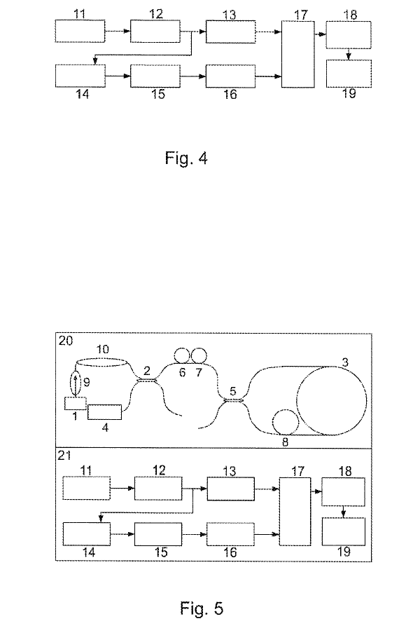

The authors of the present invention found unexpectedly that that purpose is reached by the application of a filter group preliminary separating the signal of the first and the second harmonic, the very weak first harmonic signal being amplified in such a way as to preserve its phase in relation to the phase of the signal measured by detector 4. Both signals are then subjected to synchronic conversion in two identical analogue-to-digital converters. The obtained signal is transmitted to the signal processor where a fast Fourier transform is performed concurrently on both separated signals. The diagram of the electronic processing system according to the present invention is illustrated in FIG. 4.

After separating the the first A_{1ω} and the second A_{2ω} harmonic from the detector output signal u(t),and using the following relation:

$$Ω = {S}_{o} \cdot arctg [ {S}_{e} \cdot u ( t ) ] = {S}_{o} \cdot arctg [ {S}_{e} \cdot \frac{{A}_{1 ω}}{{A}_{2 ω}} ] \qquad ( 1 )$$

where Sₒ and Sₑ are the sensor optical and electronic parts scale factors, we obtain the searched numerical values of the sensor rotational speed.

Therefore, the object of the present invention is the method to measure the amplitude ratio of two first harmonics of a signal obtained from the Sagnac system, characterised in that it comprises steps wherein:
the electrical signal from the optical detector is transmitted to a transimpedance amplifier adjusting the electrical parameters of the detection element;
the amplified signal is transmitted to the input of a programmed amplifier determining the initial amplification for the whole measurement signal;
next, the signal is separated into two paths,
one of them leads the signal directly to the input of a fast analogue-digital converter ADC which processes the whole signal of the second harmonic,
and the second part of the signal is transmitted to a group of programmed low- and band-pass filters of fixed phase characteristics, where the signal first harmonic is extracted;
after that, the extracted first harmonic signal is transmitted to the programmed amplifier input, where it is amplified to the level appropriate for the second analogue-digital converter ADC, where the conversion of the signal into the digital form synchronously with the second harmonic signal takes place;
the obtained digital signals of the first and the second harmonics are transmitted to the signal processor in order to obtain the amplitude and phase values of both signals, that the rotational speed of the fibre-optic loop is calculated from.

Preferably, the obtained signals of the first and the second harmonics are transmitted through a fast logic system made on a programmable gate array FPGA to the signal processor where the conversions are carried out simultaneously by means of fast Fourier transform in order to obtain the amplitude and phase values for both signals.

The object of the present invention is also a system to measure the amplitude ratio of the first two harmonics of the signal obtained from the Sagnac fibre-optic interferometer system, characterised in that it comprises a transimpedance amplifier connected with a program amplifier that is coupled with the first analogue-digital converter used for processing of the second harmonic signal and with the second analogue-digital converter used for processing of the first and the second harmonic signals through a group of programmed low- and band-pass filters and a programmed amplifier, both analogue-digital converters being coupled with a logic system transmitting the signals to the signal processor.

Preferably, the logic system is made on programmable gate array FPGA.

The present invention also relates to a Sagnac fibre-optic interferometer system comprising a light source in the form of a superluminescent diode connected to an isolator that is connected to a depolariser and then with a fibre-optic coupler of 2×2 type, and a pair of fibre-optic polarisers, wherein the polariser is connected to the fibre-optic coupler of 2×2 type that is further connected to a fibre-optic phase modulator and a fibre-optic loop, wherein a detector is connected to the first coupler, characterised in that it further comprises an electronic processing system according to the present invention and described above.

The object of the invention is also the application of the electronic processing system according to the present invention, described above, and a Sagnac fibre-optic interferometer system according to the present invention, described above, for detection of rotational movement, in particular seismic rotational movement and structures rotational movement.

The solutions known from the state of the art, and embodiments of the present invention are presented in the figures, where:

FIG. 1 illustrates the basic configuration of the fibre-optic system enabling interferential measurement of the Sagnac effect, i.e. the angular velocity of system rotation in the axis perpendicular to the plane of the fibre-optic loop;

FIG. 2 illustrates the minimum configuration for a fibre-optic gyroscope, that provides reversibility;

FIG. 3 illustrates the minimum configuration for a Sagnac fibre-optic interferometer with the so called open feedback loop. The presented configuration was used as the system to generate Sagnac phase shift that is detected by the present invention;

FIG. 4 is a block diagram of the electronic measurement system unit that illustrates the essence of the described invention;

FIG. 5 illustrates the system according to the present invention in the basic variant described as the embodiment of the invention.

The application of the Sagnac effect for construction of a fibre-optic gyroscope was proposed in mid 70s of the previous century. In mid eighties, the system assumed the form of a commercial apparatus, used for navigation of aircraft and vehicles, guiding missiles, and for inertial navigation of spacecraft. During the research carried out by many research grups, a few different configurations of the fibre-optic gyroscope were developed. As mentioned before, the present invention uses the minimum configuration for the Sagnac fibre-optic interferometer described in the work by R. Ulrich, “Fibre-Optic Rotation Sensing with Low Drift,” Optics Letters, Vol. 5, 1980, pp. 173-175 wherein a light source with a broad spectrum was used, additionally equipped with an isolator and fibre-optic depolariser in order to reduce the reverse signal and the polarisation noise.

The main factor that distinguishes the proposed Sagnac fibre-optic interferometer system from classical fibre-optic gyroscope structures is that fact that it measures the angular velocity and not the angle. Therefore, the problem of drift appearing in optical gyroscopes can be practically disregarded here. The effected optimisation of parameters like the loop radius, optical power of the light source, and the length of the fibre used, allowed to guarantee high sensitivity of the device of 1·10⁻⁹ rad/s/Hz^{1/2}. The determination of the angular velocity is done by measuring the amplitudes of the first (A_{1ω}) and the second (A_{2ω}) harmonics of the ouput signal according to the fomula (1).

In order to determine the harmonic components of the outupu signal, synchronous detection is used. The modulator working frequency was determined experimentally, assuming the criteria of the interferometer response linearity on lack of rotational excitation as well as maximisation of that response.

Due to the large difference between the first and the second harmonics values, providing a large dynamic range is required on their concurrent measurement.

Therefore, signal filtration was implemented, that results in appropriate separation of the signal first harmonic from much stronger second harmonic signal. In real world execution it consists in splitting the signal into two independent paths of the first and the second harmonics. Next, the signal is fed to the analogue-digital converter. The digital form of both signals is multiplied by the reference signal with the phase modulator frequency. Further digital processing enables determination of the component first and second harmonics of the recorded signal, which provides information on angular velocity.

Additionally, apart from detection properties, the system is equipped with advanced functions of data recording and transmitting and the possibility to change the measurement path remotely. The recorded data is sent, by means of the communication module, to a remote server archiving the data. The server provides access to the data and to remote control of device parameters. This is provided by a GSM/GPRS module enabling wireless communication with the remote server on a network.

The solution propsed in the present patent application is aimed at its application for measuring rotational effects in rotational seismology area. The measurement of rotational effects requires application of high sensitivity sensors operating in a broad frequency range. Currently, the problems concerning such measurements are connected with the lack of appropriate apparatus. Classical seismometers are linear velocity sensors, which definitely eliminates their application for examination of rotational movement. The recording of rotational movements is provided by gyroscopic sensors or a system of laser gyroscopes. Their presence in a seismometric array system can also be indirectly inferred.

In Polish Patent Application No. P.344540, 2000, we can find a sensor enabling the measurement of torsional vibrations. The described rotational pendulum seismometer—TAPS (Two Antiparaller Pendulum Seismometer) consists of two seismometers situated anti-parallel on a common vertical axis. However, this solution enables detection of linear velocities and then determination of the rotation and translation components from their values by means of a special mathematical procedure. This method, however, is an indirect method and can demonstrate irregularities in certain conditions caused by unevenness of attenuation factors for individual seismometer components.

Another sensor type for measuring rotational movement, the angle of rotation in principle, are optical gyroscopes based on the application of the Sagnac effect. These systems are used in aircraft navigation and in vehicle mounted systems. However, their sensitivity is generally insufficient for applications in rotational seismology, mainly due to their fitness to measure the rotation angle and not rotational speed. Furthermore, these systems, directly applied for seismic measurements, are solutions with a limited sensitivity.

It has to be stressed out that the main factor distinguishing the proposed measurement method intended for the Sagnac fibre-optic interferometer system from classical fibre-optic gyroscope structures is that fact that it measures the angular velocity and not the angle values. Such solution enables obtaining a system that eliminates the problem of drift ocurring in optical gyroscopes. Furthermore, fibre-optic gyroscopes are characterised by low measurement dynamics range and by electronic systems specialized in measuring the angle of rotation.

The proposed method enables obtaining a sensor of high dynamics and measurement accuracy. Furthermore, the presented method guarantees obtaining information on the angular velocity in a fully direct way, which contributes to the minimization of measurement uncertainty.

The present invention solves the problem of a detection system used in the fibre-optic rotational seismometer in a minimum configuration of the gyroscopic system with an open feedback loop. The system employs the measurement of the signal first and second harmonic amplitudes whose ratio provides information on the angular velocity value. The essence of the present invention is the implementation of a group of filters in order to separate the first and the second harmonics whose values differ largely, into two separate paths. So far, an analogue-digital converter of high dynamics was used, which definitely increased the cost of the detection system.

The proposed solution enables signal recording with very high accuracy and in a broad frequency range.

### DETAILED TECHNICAL DESCRIPTION OF THE INVENTION

The block diagram of the electronic measuring system is illustrated in FIG. 4.

The electrical signal from the optical detector 10 is transmitted to a transimpedance amplifier 11 adjusting the electrical parameters of the detection element. The amplified signal is transmitted to the input of a programmed amplifier 12 determining the initial amplification for the whole measurement signal. Then the signal is separated into two paths. One of them leads the signal directly to the input of a fast analogue-digital converter ADC 13 which processes the whole signal of the second harmonic. The second part of the signal is transmitted to a group of programmed low- and band-pass filters 14 of fixed phase characteristics, where the signal first harmonic is extracted. The extracted first harmonic signal is transmitted to the programmed amplifier 15 input, where it is amplified to the level appropriate for the second analogue-digital converter ADC 16, where the conversion of the signal into the digital form synchronously with the second harmonic signal takes place.

The obtained signals of the first and the second harmonics are transmitted through a fast logic system made on a programmable gate array FPGA 17 to the signal processor 18 where the conversions are carried out simultaneously by means of fast Fourier transform (FFT) in order to obtain the amplitude and phase values for both signals. These values are then converted according to the formulas (reference to the formulas above) into a numerical value corresponding to the rotational velocity of the fibre-optic loop.

These values are transmitted to a microcomputer 19 that collects the data in an internal FLASH memory of high storage capacity, analyses the signal in order to detect the required signal changes, and enables control of all elements of the measurement system.

### EMODIMENTS OF THE INVENTION

### Example

The optical component (20) of the fibre-optic rotation sensor consists of the following elements:
a source (1) in the form of a superluminescent diode (from Exalos, of the following characteristics: centre wavelength λ₀=1305.7 nm, bandwidth ΔB=31.2 nm, optical power P=9.43 mW),
an isolator (9) (from FCA, optical loss α=0.34 dB, centre wavelength λ₀=1310 nm, isolation level≥45 dB),
a depolariser (10) (from Phoenix Photonics, degree of polarization DOP <5%, optical loss α=0.20 dB),
a pair of fibre-optic couplers (2 and 5) of 2×2 type (from Phoenix Photonics, power division factors of 50:50%, optical loss α=0.20 dB),
a pair of fibre-optic polarisers (6 and 7) (from Phoenix Photonics, extinction level ϵ=43 dB, optical loss α=0.45 dB),
fibre-optic phase modulator (8) in the form of a piezo ceramic shape with resonance frequency of f=21 kHz (from Piezomechanik GmbH),
a fibre-optic loop (3) of a single-mode fibre (from Corning, SMF28e type) coiled to the diameter of about 240 mm and about 5000 mm in length,
a pair of detectors (4 and 4′) (from Optoway Technology, Inc., sensitivity S=0.9 A/W).
The important elements of the electronic processing system (21) conist of the following elements:
a transimpedance amplifier (11) (MTI04CQ from Mazet),
a programmed amplifier (12) (LTC1564 from Linear Technology),
fast analogue-digital converter (13 and 16) (AD7986 from Analog Devices),
a group of programmed low- and band-pass filters (14),
a programmed amplifier (15),
a programmed gate array FPGA (17) (XC7Z010-1CLG400C from Xilinx),
a signal processor (18) (XC7Z010-1CLG400C from Xilinx),
a microcomputer (19) (AES-Z7MB-7Z010-G from MicroZend).

The proposed solution offers broad application possibilities in rotational seismology, solving the ever growing problem of lack of experimental data concerning rotational efects, caused by the lack of appropriate detection apparatus. The field requires devices providing an extreme sensitivity of the magnitude of 10⁻⁹ rad/s/Hz^{1/2}. The presented method enables construction of a sensor fully satisfying the above conditions. The sensivity state above enables recording of rotational movements occurring during earthquakes. The research in this field can significantly contribute to the explanation of the nature of those phenomena and their physics.

Furthermore, the presented measurement method enables measuring high amplitude rotational movements of engineering structures, of the magnitude of 10 rad/s in the frequency range of 0.1-10 Hz. Continuous monitoring of rotational movements of structures is extremely important for safety. Therefore, the presented method enables obtaining a system with a broad operation range, both in terms of the amplitude and frequency.

The application of the proposed method in a three-axial layout shall enable monitoring of rotational movements simultaneously in three directions.

1. A method to measure the amplitude ratio of two first harmonics of a signal obtained from the Sagnac system, characterised in that it comprises steps wherein:
the electrical signal from an optical detector is transmitted to a transimpedance amplifier adjusting the electrical parameters of a detection element;
the amplified signal is transmitted to an input of a programmed amplifier determining the initial amplification for the whole measurement signal;
next, the signal is separated into two paths,
one of them leading the signal directly to the input of a fast analogue-digital converter ADC which processes the whole signal of the second harmonic,
and the second part of the signal being transmitted to a group of programmed low- and band-pass filters of fixed phase characteristics, where the signal first harmonic is extracted;
after that, the extracted first harmonic signal is transmitted to the programmed amplifier input, where it is amplified to the level appropriate for the second analogue-digital converter ADC, where the conversion of the signal into the digital form synchronously with the second harmonic signal takes place;
the obtained digital signals of the first and the second harmonics are transmitted to a signal processor in order to obtain the amplitude and phase values of both signals, that the rotational speed of the fibre-optic loop is calculated from.

2. The method of claim 1, characterised in that the obtained digital signals of the first and the second harmonics are transmitted through a fast logic system implemented on a programmable gate array FPGA to the signal processor where the conversions are carried out simultaneously by means of fast Fourier transform (FFT) in order to obtain the amplitude and phase values for both signals.

3. The system to measure the amplitude ratio of the first two harmonics of the signal obtained from the Sagnac fibre-optic interferometer system, characterised in that it comprises the transimpedance amplifier connected with a program amplifier that is coupled with the first analogue-digital converter used for processing of the second harmonic signal and with the second analogue-digital converter used for processing of the first and the second harmonic signals through a group of programmed low- and band-pass filters and the programmed amplifier, both analogue-digital converters being coupled with the logic system transmitting the signals to the signal processor.

4. The system of claim 3, characterised in that the logic system is implemented on programmable gate array FPGA.

5. A Sagnac fibre-optic interferometer system comprising a light source in the form of a superluminescent diode connected to an isolator that is connected to a depolariser and then with a fibre-optic coupler of 2×2 type, and a pair of fibre-optic polarisers and, wherein the polariser is connected to the fibre-optic coupler of 2×2 type that is further connected to a fibre-optic phase modulator and a fibre-optic loop, wherein a detector is connected to the first coupler, characterised in that
it further comprises an electronic processing system of claim 3.

6. An application of the system of claim 3 for the detection of rotational movements, in particular seismic rotational movements and rotational movements of structures.

7. The application of the system of claim 5 for the detection of rotational movements, in particular seismic rotational movements and rotational movements of structures.

8. A Sagnac fibre-optic interferometer system comprising a light source in the form of a superluminescent diode connected to an isolator that is connected to a depolariser and then with a fibre-optic coupler of 2×2 type, and a pair of fibre-optic polarisers and , wherein the polariser is connected to the fibre-optic coupler of 2×2 type that is further connected to a fibre-optic phase modulator and a fibre-optic loop, wherein a detector is connected to the first coupler , characterised in that
it further comprises an electronic processing system of claim 4.

9. An application of the system of claim 4 for the detection of rotational movements, in particular seismic rotational movements and rotational movements of structures.
